(19) United States
(12) Patent Application Publication
(10) Pub. No.: US 2026/0299639 A1
(43) Pub. Date: Oct. 1, 2026

(54) OPTICAL COMPUTING METHOD, LARGE-SCALE RECONFIGURABLE PHOTONIC LARGE-MATRIX MODEL, AND ARCHITECTURE

(71) Applicant: TSINGHUA UNIVERSITY, BEIJING (CN)

(72) Inventors: LU FANG, BEIJING (CN); ZHIHAO XU, BEIJING (CN)

(21) Appl. No.: 19/571,518

(22) Filed: Mar. 19, 2026

(30) Foreign Application Priority Data
Mar. 28, 2025 (CN) 202510379724X

(51) Int. Cl. G06E 1/04

(52) U.S. Cl. CPC G06E 1/045

(57) ABSTRACT

An optical computing method, performed by a large-scale reconfigurable photonic large-matrix model including hybrid optical computing sub-models, includes: acquiring a first large matrix to be computed and an input vector; inputting the first large matrix and the input vector in parallel into a respective hybrid optical computing sub-model of each parallel channel based on a quantity of parallel channels, to obtain a respective output vector of each parallel channel; and integrating the respective output vector of each parallel channel to obtain a target output vector.

### CROSS-REFERENCE TO RELATED PATENT APPLICATION

The present application is based on and claims the priority of Chinese patent application No. 202510379724X filed on Mar. 28, 2025, the entire contents of which are incorporated herein by reference.

### FIELD OF THE DISCLOSURE

The disclosure relates to the field of optical computing technology, and in particular to a large-scale reconfigurable photonic large-matrix model and a related architecture.

### BACKGROUND OF THE DISCLOSURE

With the rapid development of artificial intelligence and scientific computing, the complexity and scale of computing needs are also increasing. Light has natural advantages such as high throughput and low latency during propagation. Optical computing technology that uses photons instead of electrons as computing carriers.

### SUMMARY OF THE DISCLOSURE

Embodiments of a first aspect of the disclosure provide an optical computing method, performed by a large-scale reconfigurable photonic large-matrix model including hybrid optical computing sub-models, the method includes: acquiring a first large matrix to be computed and an input vector; inputting the first large matrix and the input vector in parallel into a respective hybrid optical computing sub-model of each parallel channel based on a quantity of parallel channels, to obtain a respective output vector of each parallel channel; and integrating the respective output vector of each parallel channel to obtain a target output vector.

Embodiments of a second aspect of the disclosure provide a large-scale reconfigurable photonic large-matrix model, including hybrid optical computing sub-models. The large-scale reconfigurable photonic large-matrix model includes an obtainer, a parallel inputter and an integrator. The obtainer is configured to acquire a first large matrix to be computed and an input vector. The parallel inputter is configured to input the first large matrix and the input vector in parallel into a respective hybrid optical computing sub-model of each parallel channel based on a quantity of parallel channels, to obtain a respective output vector of each parallel channel. The integrator is configured to integrate the respective output vector of each parallel channel to obtain a target output vector.

Embodiments of a third aspect of the disclosure provide a large-scale reconfigurable photonic large-matrix architecture, including the large-scale reconfigurable photonic large-matrix model including hybrid optical computing sub-models. The large-scale reconfigurable photonic large-matrix model includes an obtainer, a parallel inputter and an integrator. The obtainer is configured to acquire a first large matrix to be computed and an input vector. The parallel inputter is configured to input the first large matrix and the input vector in parallel into a respective hybrid optical computing sub-model of each parallel channel based on a quantity of parallel channels, to obtain a respective output vector of each parallel channel. The integrator is configured to integrate the respective output vector of each parallel channel to obtain a target output vector.

### BRIEF DESCRIPTION OF THE DRAWINGS

The above and/or additional aspects and advantages of the disclosure will become apparent and easily understood from the following description of the embodiments in conjunction with the accompanying drawings.

FIG. 1 is a flowchart illustrating an optical computing method according to an embodiment of the disclosure.

FIG. 2 is a schematic diagram illustrating the structure of a large-scale reconfigurable photonic large-matrix model according to an embodiment of the disclosure.

FIG. 3 is a schematic diagram illustrating the structure of a hybrid optical computing sub-model according to an embodiment of the disclosure.

### DETAILED DESCRIPTION OF THE EXEMPLARY EMBODIMENTS

Embodiments of the disclosure are described in detail below, and examples of the embodiments are shown in the accompanying drawings, in which the same or similar reference numerals throughout represent the same or similar elements or elements having the same or similar functions. The embodiments described below with reference to the accompanying drawings are illustrative and are intended to explain the disclosure, and should not be construed as limiting the disclosure.

With the rapid development of artificial intelligence and scientific computing, the complexity and scale of computing needs are also increasing. The performance of existing large-scale matrix computing is gradually approaching saturation, making it difficult to effectively cope with the increasingly stringent demands of large-scale complex algorithms for computing power and power consumption. Light has natural advantages such as high throughput and low latency during propagation. Optical computing technology that uses photons instead of electrons as computing carriers is seen as the key to breaking the existing computing bottleneck.

Currently, for most analog computing architectures, signals may attenuate during transmission and processing, and noise may also affect the quality of the signal. This may lead to errors or instability in the computation result. For an optical computing model, due to factors such as material defects, wavefront errors, and uneven transmission in the optical system, various errors will inevitably be introduced in optical computation. These errors may affect the accuracy of the computation result and cause a deviation between the experimental result and the simulation data. If the optical neural network parameters are expanded by simply stacking the number of layers, the errors will gradually accumulate during propagation, eventually causing huge errors in the output.

In the existing technology, the classification of four vowel sound wave signals may be achieved through an array composed of 56 cascaded Mach-Zehnder Interferometers (MZI), or visual tasks, such as handwritten digit recognition and image saliency detection, may be achieved through a deep diffraction neural network based on a cascade of optical diffraction masks; the splitting and aggregation of the optical path may give the ability of multi-channel parallel processing to the diffracted light computation.

However, the computing effect of the above-mentioned existing technology is described by the classification/regression accuracy of a certain intelligent computing task, and cannot be measured by the precision deviation of a certain operation. Further, the above-mentioned optical computing is difficult to deeply cascade the computing operators, which limits the representation ability and computing scale of optical computing.

The disclosure is described in detail below with reference to specific embodiments.

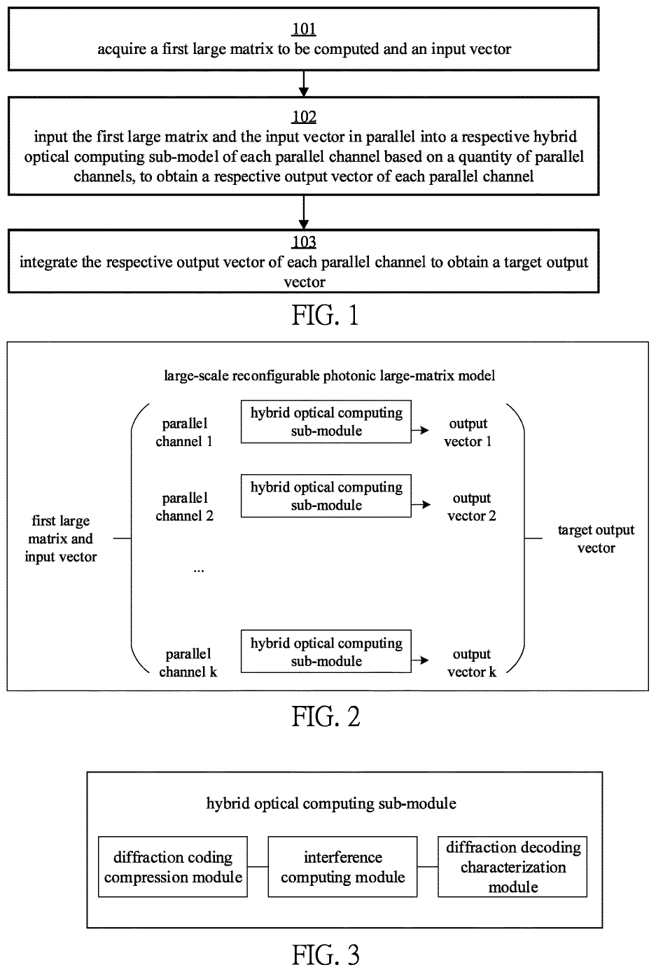

FIG. 1 is a flowchart illustrating an optical computing method according to an embodiment of the disclosure. The optical computing method is performed by a large-scale reconfigurable photonic large-matrix model, which will be described in detail below. The optical computing method uses photons instead of electrons as computing carriers to solve the computing tasks.

As illustrated in FIG. 1, the method includes the following.

At 101, a first large matrix to be computed and an input vector are acquired.

At 102, the first large matrix and the input vector are inputted in parallel to a respective hybrid optical computing sub-modes of each parallel channel of the model based on a quantity of parallel channels to obtain a respective output vector of each parallel channel.

At 103, the respective output vector of each parallel channel is integrated to obtain a target output vector.

In some embodiments, inputting the first large matrix and the input vector in parallel into the respective hybrid optical computing sub-model of each parallel channel includes compressing the first large matrix and the input vector into a second large matrix and a first vector; performing an arbitrary matrix multiplication on the second large matrix and the first vector to obtain a second vector; and computing a second weight for diffraction decoding based on the second vector to obtain the respective output vector of each parallel channel.

In some embodiments, performing the arbitrary matrix multiplication on the second large matrix and the first vector to obtain the second vector includes obtaining the second vector by performing the arbitrary matrix multiplication using a Mach-Zehnder Interferometer (MZI) or crossbar structure based on the second large matrix and the first vector.

In some embodiments, compressing the first large matrix and the input vector into the second large matrix and the first vector includes down-sampling the input vector to the first vector, and compressing the first large matrix into the second large matrix through a first weight computed through diffraction modulation.

In some embodiments, integrating the respective output vector of each parallel channel to obtain the target output vector includes: performing a weighted summation on the respective output vector of each parallel channel to obtain the target output vector.

In some embodiments, the hybrid optical computing sub-model adopts a diffraction-interference-diffraction structure.

FIG. 2 is a schematic diagram illustrating the structure of a large-scale reconfigurable photonic large-matrix model according to an embodiment of the disclosure. As illustrated in FIG. 2, the large-scale reconfigurable photonic large-matrix model includes hybrid optical computing sub-models. The large-scale reconfigurable photonic large-matrix model includes an acquisition module, a parallel input module and an integration module.

The acquisition module is configured to obtain a first large matrix to be computed and an input vector.

The parallel input module is configured to input the first large matrix and the input vector in parallel into a respective hybrid computing sub-model of each parallel channel based on a quantity of parallel channels, to obtain a respective output vector of each parallel channel.

The integration module is configured to integrate the respective output vector of each parallel channel to obtain a target output vector.

In an embodiment of the disclosure, the above-mentioned large-scale reconfigurable photonic large-matrix model is suitable for large-matrix computing. Based on this, the above-mentioned large-scale reconfigurable photonic large-matrix model may be applied in a variety of scenarios, such as the classification of intelligent computing tasks, or an intelligent question-and-answer scenario.

In an embodiment of the disclosure, the large-scale reconfigurable photonic large-matrix model may split the super-large parameter matrix encoding into multiple groups of parallel finite-scale parameter-reconfigurable sub-matrices, and further decode and fuse operation results of the sub-matrices into a final result output of a large-matrix operation. In an embodiment of the disclosure, an approximate fitting of arbitrary matrix multiplication operations may be achieved by the “diffraction-interference-diffraction” hybrid optical computing sub-models.

In an embodiment of the disclosure, the quantity of parallel channels may be determined based on a computing accuracy requirement. The more parallel channels there are, the higher the corresponding computing accuracy. After the quantity of parallel channels is determined based on the computing accuracy requirement, each parallel channel corresponds to a respective hybrid optical computing sub-model, such that a hybrid optical computing model array is constructed, thereby achieving adaptive and precise fitting for the parameter scale of the arbitrary matrix multiplication operations.

In an embodiment of the disclosure, multiple parallel hybrid optical computing sub-models in the hybrid optical computing model array are jointly trained, and each hybrid optical computing sub-model corresponds to its own weight parameter.

In an embodiment of the disclosure, FIG. 3 is a schematic diagram illustrating the structure of a hybrid optical computing sub-model according to an embodiment of the disclosure. As illustrated in FIG. 3, the hybrid optical computing sub-model includes a diffraction coding compression module, an interference computing module and a diffraction decoding representation module. An output of the diffraction coding compression module is an input of the interference computing module, and an output of the interference computing module is an input of the diffraction decoding representation module.

In an embodiment of the disclosure, the diffraction coding compression module is configured to compress the first large matrix and the input vector into a second large matrix and a first vector. The interference computing module is configured to perform an arbitrary matrix multiplication based on the second large matrix and the first vector to obtain a second vector. The diffraction decoding characterization module is configured to compute a second weight for diffraction decoding based on the second vector to obtain a respective output vector of each parallel channel.

In an embodiment of the disclosure, the diffraction coding compression module is configured to: down-sample the input vector into a first vector, and compress the first large matrix into a second large matrix by using a first weight computed through diffraction modulation. A dimension of the first vector is smaller than a dimension of the input vector.

For example, in an embodiment of the disclosure, assuming that the dimension of the input vector is N and the dimension of the first large matrix is N*N, the diffraction coding compression module may down-sample the input vector to the first vector of M dimensions (M<N), and compress the first large matrix having N channels into the second large matrix having M channels using the first weight computed through the diffraction modulation.

In an embodiment of the disclosure, the interference computing module is configured to: perform an arbitrary matrix multiplication using an MZI or crossbar structure based on the second large matrix and the first vector, to obtain the second vector.

For example, in an embodiment of the disclosure, the interference computing module may use the MZI or crossbar structure to perform an arbitrary matrix multiplication of M*M based on the second large matrix and the first vector, to obtain the second vector. The dimension of the second vector is 1×M.

Further, in an embodiment of the disclosure, in computing, by the diffraction decoding characterization module, the second weight for the diffraction decoding based on the second vector to obtain the respective output vector of each parallel channel, the M-dimensional second vector output by the interference computing module may be restored to an N-dimensional output vector through computing the second weight for the diffraction decoding, that is, the dimension of the output vector is the same as the dimension of the input vector.

In addition, in one embodiment of the disclosure, 100 k groups of arbitrary input vectors may be selected, and corresponding 100 k groups of ground truth value operation outputs may be obtained through operations on the N*N dimensional matrix to be fitted, thereby obtaining the data set required for training the above-mentioned hybrid optical computing model array. The data set is used to train the hybrid optical computing model array to obtain the respective weight parameter of each hybrid optical computing sub-model. Therefore, the effect of optical computation is close to the operation effect of the actual matrix to be fitted.

Further, in one embodiment of the disclosure, the above-mentioned integration module is configured to: perform a weighted summation on the respective output vector of each parallel channel to obtain the target output vector.

In an embodiment of the disclosure, for the N*N-dimensional large-scale matrix to be computed, the joint optimization computation of multiple M*M parallel small matrices may be used to obtain the required result within the allowable error range. In the current Transformer-based large matrix operation, the matrix to be computed generally has a strong sparsity (that is, the parameter redundancy is large). The use of the above-mentioned large-scale reconfigurable photonic large-matrix model may effectively reduce the number of multiplication and addition calculations in the matrix operations, making the operation more efficient. At the same time, the above-mentioned matrix operation splitting method may theoretically enable small-scale computing hardware to support the computation of larger matrices through reuse, and has strong scalability.

In conclusion, the model according to the embodiments of the disclosure parallelizes the first large matrix element array into multiple groups of finite-scale matrix element array operation channels through a multi-channel parallel strategy, and realizes the adaptive and precise fitting for the parameter scale of arbitrary matrix multiplication operations through multiple hybrid optical computing sub-models. While taking into account high computing accuracy and high data throughput, a new paradigm of large-scale universal optical matrix operations is realized, which may support complex optical universal computing tasks, has broad application prospects, and may be applied to unmanned systems, autonomous driving, ultrafast science and other fields.

In order to implement the above embodiments, the disclosure also provides a large-scale reconfigurable photonic large-matrix architecture, including: a large-scale reconfigurable photonic large-matrix model according to at least one of the above embodiments.

For example, the architecture includes: a plurality of hybrid optical computing sub-models. The plurality of hybrid optical computing sub-models are connected in parallel.

For example, the hybrid optical computing sub-model includes a diffraction coding compression module, an interference computing module and a diffraction decoding characterization module. An output of the diffraction coding compression module is an input of the interference computing module, and an output of the interference computing module is an input of the diffraction decoding characterization module.

The collection, storage, use, processing, transmission, provision and disclosure of user personal information involved in this disclosure shall comply with the relevant laws and regulations and shall not violate public order and good morals.

It should be noted that personal information from users should be collected for legitimate and reasonable purposes and should not be shared or sold outside of these legitimate uses. In addition, such collection/sharing should be carried out after receiving the user's informed consent, including but not limited to notifying the user to read the user agreement/user notice and sign the agreement/authorization including authorization of relevant user information before the user uses the function. In addition, any necessary steps should be taken to protect and safeguard access to such personal information data and ensure that others who have access to personal information data comply with its privacy policy and procedures.

The disclosure anticipates providing implementation schemes for users to selectively block the use or access of personal information data. That is, the disclosure anticipates providing hardware and/or software to prevent or block access to such personal information data. Once the personal information data is no longer needed, risks may be minimized by limiting data collection and deleting the data. In addition, when applicable, such personal information is de-identified to protect the privacy of the user.

The acquisition, transmission, storage, use, and processing of data in the technical solution according to the disclosure are in compliance with the relevant provisions of national laws and regulations.

It should be noted that in the embodiments of the disclosure, certain software, components, models and other existing solutions in the industry may be mentioned, which should be regarded as examples. Their purpose is only to illustrate the feasibility of implementing the technical solution of the disclosure, but it does not mean that the applicant has or will necessarily use the solution.

In the description of the aforementioned embodiments, the description with reference to the terms “one embodiment”, “some embodiments”, “example”, “specific example”, or “some examples” etc. means that the specific features, structures, materials or characteristics described in conjunction with the embodiment or example are included in at least one embodiment or example of the disclosure. In this specification, the schematic representations of the above terms do not necessarily refer to the same embodiment or example. Moreover, the specific features, structures, materials or characteristics described may be combined in any one or more embodiments or examples in a suitable manner. In addition, those skilled in the art may combine and combine the different embodiments or examples described in this specification and the features of the different embodiments or examples, unless they contradict each other.

In addition, the terms “first” and “second” are used for descriptive purposes only and should not be understood as indicating or implying relative importance or implicitly indicating the number of the indicated technical features. Thus, a feature defined as “first” or “second” may explicitly or implicitly include at least one of the features. In the description of the disclosure, “plurality” means at least two, such as two, three, etc., unless otherwise clearly and specifically defined.

Any process or method description in a flowchart or otherwise described herein may be understood to represent a module, segment or portion of code that includes one or more executable instructions for implementing the steps of a custom logical function or process, and the scope of the preferred embodiments of the disclosure includes additional implementations in which functions may not be performed in the order shown or discussed, including performing functions in a substantially simultaneous manner or in reverse order depending on the functions involved, which should be understood by technicians in the technical field to which the embodiments of the disclosure belong.

The logic and/or steps represented in the flowchart or otherwise described herein, for example, may be considered as an ordered list of executable instructions for implementing logical functions, and may be embodied in any computer-readable medium for use by an instruction execution system, device or apparatus (such as a computer-based system, a system including a processor, or other system that may fetch instructions from an instruction execution system, device or apparatus and execute instructions), or in combination with these instruction execution systems, devices or apparatuses. For the purposes of this specification, “computer-readable medium” may be any device that may contain, store, communicate, propagate or transmit a program for use by an instruction execution system, device or apparatus, or in combination with these instruction execution systems, devices or apparatuses. More specific examples (non-exhaustive list) of computer-readable media include the following: an electrical connection with one or more wires (electronic device), a portable computer disk box (magnetic device), a random access memory (RAM), a read-only memory (ROM), an erasable and programmable read-only memory (EPROM or flash memory), an optical fiber device, and a portable compact disk read-only memory (CDROM). In addition, the computer-readable medium may even be paper or other suitable medium on which the program is printed, since the program may be obtained electronically, for example, by optically scanning the paper or other medium and then editing, interpreting or otherwise processing in a suitable manner if necessary, and then stored in a computer memory.

It should be understood that the various parts of the disclosure may be implemented in hardware, software, firmware or a combination thereof. In the above-mentioned embodiments, multiple steps or methods may be implemented in software or firmware stored in a memory and executed by a suitable instruction execution system. For example, if implemented in hardware, as in another embodiment, it may be implemented by any one of the following technologies known in the art or their combination: a discrete logic circuit having a logic gate circuit for implementing a logic function for a data signal, a dedicated integrated circuit having a suitable combination of logic gate circuits, a programmable gate array (PGA), a field programmable gate array (FPGA), etc.

A person skilled in the art may understand that all or part of the steps in the above-mentioned embodiment methods may be completed by instructing related hardware through a program, and the program may be stored in a computer-readable storage medium, which, when executed, includes one or a combination of the steps of the method embodiments.

In addition, each functional unit in each embodiment of the disclosure may be integrated into a processing module, or each unit may exist physically separately, or two or more units may be integrated into one module. The above-mentioned integrated module may be implemented in the form of hardware or in the form of a software functional module. If the integrated module is implemented in the form of a software functional module and sold or used as an independent product, it may also be stored in a computer-readable storage medium.

The storage medium mentioned above may be a read-only memory, a disk or an optical disk, etc. Although the embodiments of the disclosure have been shown and described above, it may be understood that the above embodiments are illustrative and cannot be understood as limitations of the disclosure. A person of ordinary skill in the art may change, modify, replace and modify the above embodiments within the scope of the disclosure.

What is claimed is:

1. An optical computing method, performed by a large-scale reconfigurable photonic large-matrix model comprising hybrid optical computing sub-models, wherein the method comprises:
acquiring a first large matrix to be computed and an input vector;
inputting the first large matrix and the input vector in parallel into a respective hybrid optical computing sub-model of each parallel channel based on a quantity of parallel channels, to obtain a respective output vector of each parallel channel; and
integrating the respective output vector of each parallel channel to obtain a target output vector.

2. The method of claim 1, wherein inputting the first large matrix and the input vector in parallel into the respective hybrid optical computing sub-model of each parallel channel to obtain the respective output vector of each parallel channel comprises:
compressing the first large matrix and the input vector into a second large matrix and a first vector;
performing an arbitrary matrix multiplication on the second large matrix and the first vector to obtain a second vector; and
computing a second weight for diffraction decoding based on the second vector to obtain the respective output vector of each parallel channel.

3. The method of claim 2, wherein performing the arbitrary matrix multiplication on the second large matrix and the first vector to obtain the second vector comprises:
obtaining the second vector by performing the arbitrary matrix multiplication using a Mach-Zehnder Interferometer (MZI) or crossbar structure based on the second large matrix and the first vector.

4. The method of claim 2, wherein compressing the first large matrix and the input vector into the second large matrix and the first vector comprises:
down-sampling the input vector to the first vector, and compressing the first large matrix into the second large matrix through a first weight computed through diffraction modulation.

5. The method of claim 1, wherein integrating the respective output vector of each parallel channel to obtain the target output vector comprises:
performing a weighted summation on the respective output vector of each parallel channel to obtain the target output vector.

6. The method of claim 1, wherein the hybrid optical computing sub-model adopts a diffraction-interference-diffraction structure.

7. A large-scale reconfigurable photonic large-matrix model, comprising hybrid optical computing sub-models; an obtainer, a parallel inputter and an integrator,
the obtainer is configured to acquire a first large matrix to be computed and an input vector;
the parallel inputter is configured to input the first large matrix and the input vector in parallel into a respective hybrid optical computing sub-model of each parallel channel based on a quantity of parallel channels, to obtain a respective output vector of each parallel channel; and
the integrator is configured to integrate the respective output vector of each parallel channel to obtain a target output vector.

8. The large-scale reconfigurable photonic large-matrix model of claim 7, comprising hybrid optical computing sub-models, wherein the hybrid optical computing sub-model comprises a diffraction coding compressor, an interference computer and a diffraction decoder, an output of the diffraction coding compressor is an input of the interference computer, and an output of the interference computer is an input of the diffraction decoder.

9. The large-scale reconfigurable photonic large-matrix model of claim 8, wherein the diffraction coding compressor is configured to compress the first large matrix and the input vector into a second large matrix and a first vector;
the interference computer is configured to perform an arbitrary matrix multiplication on the second large matrix and the first vector to obtain a second vector; and
the diffraction decoder is configured to compute a second weight for diffraction decoding based on the second vector to obtain the respective output vector of each parallel channel.

10. The large-scale reconfigurable photonic large-matrix model of claim 9, wherein the interference computer is configured to: obtain the second vector by performing the arbitrary matrix multiplication using a Mach-Zehnder Interferometer (MZI) or crossbar structure based on the second large matrix and the first vector.

11. The large-scale reconfigurable photonic large-matrix model of claim 9, wherein the diffraction coding compressor is configured to: down-sample the input vector to the first vector, and compress the first large matrix into the second large matrix through a first weight computed through diffraction modulation.

12. The large-scale reconfigurable photonic large-matrix model of claim 7, wherein the integrator is configured to: perform a weighted summation on the respective output vector of each parallel channel to obtain the target output vector.

13. The large-scale reconfigurable photonic large-matrix model of claim 7, wherein the hybrid optical computing sub-models are connected in parallel.

14. The large-scale reconfigurable photonic large-matrix model of claim 7, wherein the hybrid optical computing sub-model adopts a diffraction-interference-diffraction structure.

15. A large-scale reconfigurable photonic large-matrix architecture, comprising a large-scale reconfigurable photonic large-matrix model comprising hybrid optical computing sub-models, wherein the large-scale reconfigurable photonic large-matrix model comprises an obtainer, a parallel inputter and an integrator,
the obtainer is configured to acquire a first large matrix to be computed and an input vector;
the parallel inputter is configured to input the first large matrix and the input vector in parallel into a respective hybrid optical computing sub-model of each parallel channel based on a quantity of parallel channels, to obtain a respective output vector of each parallel channel; and
the integrator is configured to integrate the respective output vector of each parallel channel to obtain a target output vector.

16. The architecture of claim 15, wherein the plurality of hybrid optical computing sub-models are connected in parallel.

17. The architecture of claim 16, wherein the hybrid optical computing sub-model comprises a diffraction coding compressor, an interference computer and a diffraction decoder, an output of the diffraction coding compressor is an input of the interference computer, and an output of the interference computer is an input of the diffraction decoder.

18. The architecture of claim 15, wherein the diffraction coding compressor is further configured to compress the first large matrix and the input vector into a second large matrix and a first vector;
the interference computer is configured to perform an arbitrary matrix multiplication on the second large matrix and the first vector to obtain a second vector; and
the diffraction decoder is configured to compute a second weight for diffraction decoding based on the second vector to obtain the respective output vector of each parallel channel.

19. The architecture of claim 18, wherein the interference computer is further configured to:
obtain the second vector by performing the arbitrary matrix multiplication using a Mach-Zehnder Interferometer (MZI) or crossbar structure based on the second large matrix and the first vector.

20. The architecture of claim 18, wherein the diffraction coding compressor is further configured to:
down-sample the input vector to the first vector, and compress the first large matrix into the second large matrix through a first weight computed through diffraction modulation.
